(19) United States
(12) Patent Application Publication
(10) Pub. No.: US 2025/0300241 A1
(43) Pub. Date: Sep. 25, 2025

(54) ELECTROLYTES FOR RECHARGEABLE LITHIUM BATTERIES AND RECHARGEABLE LITHIUM BATTERIES INCLUDING THE SAME

(71) Applicant: SAMSUNG SDI CO., LTD., Yongin-si (KR)

(72) Inventors: Sohee KIM, Yongin-si (KR); Sanghoon KIM, Yongin-si (KR); Hyunbong CHOI, Yongin-si (KR); Injun PARK, Yongin-si (KR); Sangwoo PARK, Yongin-si (KR); Hongryeol PARK, Yongin-si (KR); Yeji YANG, Yongin-si (KR)

(21) Appl. No.: 18/923,294

(22) Filed: Oct. 22, 2024

(30) Foreign Application Priority Data
Mar. 21, 2024 (KR) 10-2024-0039352

(51) Int. Cl. H01M 10/42; H01M 4/02; H01M 4/525; H01M 10/052; H01M 10/0567; H01M 10/0569

(52) U.S. Cl. CPC H01M 10/4235; H01M 4/525; H01M 10/052; H01M 10/0567; H01M 10/0569; H01M 2004/028; H01M 2300/004

(57) ABSTRACT

A rechargeable lithium battery and a rechargeable lithium battery including an electrolyte, the electrolyte for a rechargeable lithium battery including a non-aqueous organic solvent; a lithium salt; a first additive represented by Chemical Formula 1; and a second additive represented by Chemical Formula 2:

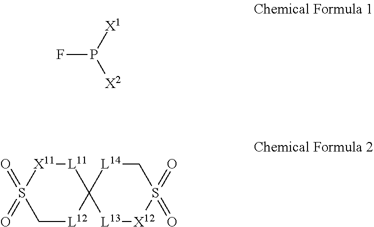

### CROSS-REFERENCE TO RELATED APPLICATION

The present application claims priority to and the benefit of Korean Patent Application No. 10-2024-0039352 filed in the Korean Intellectual Property Office on Mar. 21, 2024, the entire content of which is incorporated herein by reference.

### BACKGROUND

### 1. Field

Embodiments of the present disclosure described herein are related to electrolytes for rechargeable lithium batteries and rechargeable lithium batteries including the same.

### 2. Description of the Related Art

A rechargeable lithium battery may be recharged and has three or more times as high energy density per unit weight as a lead storage battery, a nickel-cadmium battery, a nickel hydrogen battery, a nickel zinc battery and/or the like. That is, a rechargeable lithium battery can be recharged and possesses an energy density that is at least three times greater per unit of weight compared to comparable batteries such as lead-acid, nickel-cadmium, nickel-metal hydride, or nickel-zinc types. It may be also charged at a higher rate and thus, is commercially manufactured for a laptop, a cell phone, an electric tool, an electric bike, and/or the like, and research on improvement of additional energy density have been actively made. That is, the rechargeable lithium battery may also be charged more rapidly, making it a popular choice for commercial production in devices like laptops, cell phones, electric tools, and/or electric bicycles. Here, active research is also underway to further enhance its energy density.

A rechargeable lithium battery may be manufactured by injecting an electrolyte into an electrode assembly, which includes a positive electrode including a positive electrode active material capable of intercalating/deintercalating lithium ions and a negative electrode including a negative electrode active material capable of intercalating/deintercalating lithium ions.

As charging and discharging of a rechargeable lithium battery is repeated, transition metal ions in the positive electrode active material are eluted into the electrolyte, and the transition metal ions eluted into the electrolyte are reduced on the surface of the negative electrode. Accordingly, side reactions (e.g., gas generation, increased interface resistance, and/or the like) occur at the interface between the negative electrode and the electrolyte, and cycle-life of the rechargeable lithium battery may be reduced.

The above problems become more severe if (e.g., when) the rechargeable lithium battery is driven at high temperature and/or charged at high voltage (e.g., about 4.5 V or higher.

### SUMMARY

Aspects according to one or more embodiments are directed toward an electrolyte for a rechargeable lithium battery which suppresses or reduces elution of transition metal ions in the positive electrode active material and prevents or reduces side reactions (e.g., gas generation, increase in interface resistance, and/or the like) that occur at the interface between the negative electrode and the electrolyte, regardless of operating temperature and upper charging limit voltage, and improves cycle-life of a rechargeable lithium battery.

Aspects according to one or more embodiments are directed toward a rechargeable lithium battery including the electrolyte.

Additional aspects will be set forth in part in the description which follows and, in part, will be apparent from the description, or may be learned by practice of the presented embodiments of the present disclosure.

According to one or more embodiments, an electrolyte for a rechargeable lithium battery may include a non-aqueous organic solvent; a lithium salt; a first additive represented by Chemical Formula 1; and a second additive represented by Chemical Formula 2:

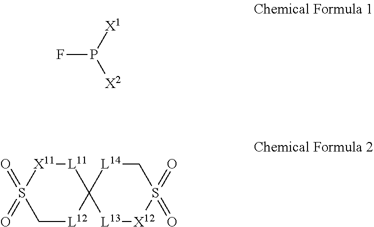

According to one or more embodiments, a rechargeable lithium battery may include a positive electrode including a positive electrode active material; a negative electrode including a negative electrode active material; and the electrolyte.

### BRIEF DESCRIPTION OF THE DRAWINGS

FIGS. 1-4 are schematic views each showing rechargeable lithium batteries according to one or more embodiments.

### DETAILED DESCRIPTION

Hereinafter, embodiments will be described in more detail. However, these embodiments are example, the present disclosure is not limited thereto and the present disclosure is defined by the scope of claims.

As used herein, if (e.g., when) specific definition is not otherwise provided, it will be understood that if (e.g., when) an element such as a layer, film, region, or substrate is referred to as being “on” another element, it can be directly on the other element or intervening elements may also be present.

As used herein, if (e.g., when) specific definition is not otherwise provided, the singular may also include the plural. In addition, unless otherwise specified, “A or B” may refer to “including A, including B, or including A and B.”

As utilized herein, expressions such as “at least one of”, “one of”, and “of (e.g., selected from among)”, when preceding a list of elements, modify the entire list of elements and do not modify the individual elements of the list. For example, “at least one of a, b or c”, “at least one selected from among a, b and c”, and/or the like, may indicate only a, only b, only c, both (e.g., simultaneously) a and b, both (e.g., simultaneously) a and c, both (e.g., simultaneously) b and c, all of a, b, and c, or variations thereof.

The term utilized herein is intended to describe only a specific embodiment and is not intended to limit the present disclosure. As utilized herein, the singular forms “a,” “an,” and “the” are intended to include the plural forms, including “at least one,” unless the content (e.g., amount) clearly indicates otherwise. “At least one” should not be construed as being limited to the singular. As utilized herein, the term “and/or” includes any and all combinations of one or more of the associated listed items. The terms “includes,” “including,” “comprises,” and/or “comprising,” when utilized in the detailed description, specify a presence of stated features, regions, integers, steps, operations, elements, and/or components, but do not preclude the presence or addition of one or more other features, regions, integers, steps, operations, elements, components, and/or groups thereof.

Spatially relative terms such as “beneath,” “below,” “lower,” “above,” and “upper” may be utilized herein to easily describe one element or feature's relationship to another element or feature. It will be understood that the spatially relative terms are intended to encompass different orientations of a device in utilize or operation in addition to the orientation illustrated in the drawings. For example, when a device in the drawings is turned over, elements described as “below” or “beneath” other elements or features would then be “above” or “over” the other elements or features. In some embodiments, the example term “below” may encompass both (e.g., simultaneously) orientations of above and below. The device may be otherwise oriented (rotated 90 degrees or at other orientations), and the spatially relative terms utilized herein may be interpreted accordingly.

As utilized herein, the term “substantially” and similar terms are utilized as terms of approximation and not as terms of degree, and are intended to account for the inherent deviations in measured or calculated values that would be recognized by those of ordinary skill in the art. Also, the term “about” and similar terms, when utilized herein in connection with a numerical value or a numerical range, are inclusive of the stated value and a value within an acceptable range of deviation for the particular value as determined by one of ordinary skill in the art, considering the measurement in question and the error associated with measurement of the particular quantity (e.g., the limitations of the measurement system). For example, “about” may refer to within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A person of ordinary skill in the art would appreciate, in view of the present disclosure in its entirety, would appreciate that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the context of the present application and unless otherwise defined, the terms “use,” “using,” and “used” may be considered synonymous with the terms “utilize,” “utilizing,” and “utilized,” respectively.

Further, the use of “may” when describing embodiments of the inventive concept refers to “one or more embodiments of the inventive concept.” Also, the term “exemplary” is intended to refer to an example or illustration.

As used herein, “combination thereof” may refer to a mixture of constituents, a stack, a composite, a copolymer, an alloy, a blend, and a reaction product.

As used herein, if (e.g., when) specific definition is not otherwise provided, “substituted” refers to replacement of at least one hydrogen atom of a compound by a substituent selected from among a halogen atom (F, Cl, Br, or I), a hydroxyl group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, and/or a (e.g., any suitable) combination thereof.

As used herein, if (e.g., when) specific definition is not otherwise provided, “heterocycloalkyl group,” “heterocycloalkenyl group,” “heterocycloalkynyl group,” and “heterocycloalkylene group” refers to that at least one heteroatom of N, O, S or P is present in the ring compound of cycloalkyl, cycloalkenyl, cycloalkynyl, and cycloalkylene, respectively.

In chemical formulas of the present specification, unless a specific definition is otherwise provided, hydrogen is bonded at the position if (e.g., when) a chemical bond is not drawn where supposed to be given.

### Electrolyte

One or more embodiments include an electrolyte for a rechargeable lithium battery including a non-aqueous organic solvent; a lithium salt; a first additive represented by Chemical Formula 1; and a second additive represented by Chemical Formula 2:

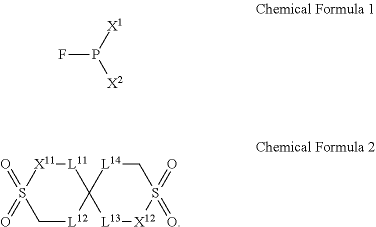

The first additive and the second additive are each compound that can be oxidized and decomposed on the surface of the positive electrode.

For example, the first additive and the second additive are additives having a phosphite structure and a sulphite structure, respectively, and both (e.g., simultaneously) oxidize and decompose on the surface of the positive electrode to form a robust positive electrode protective film (CEI, Cathode Electrolyte Interface). That is, the first additive possesses a phosphite configuration while the second one features a sulphite configuration. Together, they undergo simultaneous oxidation and decomposition upon the positive electrode's surface, culminating in the formation of a durable protective film at the Cathode Electrolyte Interface (CEI).”

The phosphorus (P)-based and sulfur (S)-based films produced by oxidative decomposition of the first additive and the second additive are structurally stable compounds, forming a robust film on the surface of the positive electrode to suppress or reduce elution of transition metal ions in the positive electrode active material into the electrolyte. As a result, side reactions (e.g., gas generation, increase in interface resistance, and/or the like) that occur at the interface between the negative electrode and the electrolyte can be suppressed or reduced and the cycle-life of the rechargeable lithium battery can be improved.

This effect is effectively exhibited even if a driving temperature of the rechargeable lithium battery is increased and/or the upper charging limit voltage is increased.

Hereinafter, an electrolyte for a rechargeable lithium battery of one or more embodiments will be described in more detail.

### First Additive

In Chemical Formula 1, X¹ and X² are each a halogen group or —O-L¹-R¹. However, at least one selected from among X¹ and X² is —O-L¹-R¹.

L¹ may be a single bond, or a substituted or unsubstituted C1 to C10 alkylene group.

R¹ may be a cyano group (—CN), a difluorophosphite group (—OPF₂), a substituted or unsubstituted C1 to C10 alkyl group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group.

When X¹ and X² are —O-L¹-R¹ at the same time, R¹ may each independently be present (e.g., may not linked to each other). That is, when X¹ and X² both exhibit the structure —O-L¹-R¹, each R¹ may independently exist.

At this time, one selected from among X¹ and X² may be a fluoro atom and the other may be O-L²-R².

L² may be a single bond or a substituted or unsubstituted C1 to C10 alkylene group.

R² may be a cyano group (—CN) or a difluorophosphite group (—OPF₂).

When X¹ and X² are concurrently (e.g., simultaneously) —O-L¹-R¹, independently of the foregoing description, two R¹s may be linked to form a substituted or unsubstituted monocyclic or polycyclic C6 to C20 aliphatic heterocycle, or a substituted or unsubstituted monocyclic or polycyclic C6 to C20 aromatic heterocycle.

At this time, among X¹ and X², one may be —O-L³-R³ and the other may be —O-L⁴-R⁴.

L³ and L⁴ may each independently be a single bond or a substituted or unsubstituted C1 to C10 alkylene group.

R³ and R⁴ may each independently be a substituted or unsubstituted C1 to C10 alkyl group. In one or more embodiments, R³ and R⁴ may be linked to form a substituted or unsubstituted monocyclic or polycyclic C3 to C10 aliphatic heterocycle.

For example, Chemical Formula 1 may be represented by Chemical Formula 1-1 or Chemical Formula 1-2:

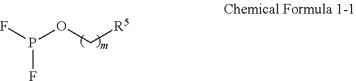

In Chemical Formula 1-1, m may be an integer of 1 to 5; and R⁵ may be a cyano group (—CN) or a difluorophosphite group (—OPF₂).

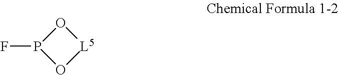

In Chemical Formula 1-2, L⁵ may be a substituted or unsubstituted C1 to C5 alkylene group.

For a more detailed example, Chemical Formula 1-2 may be represented by Chemical Formula 1-2a or Chemical Formula 1-2b:

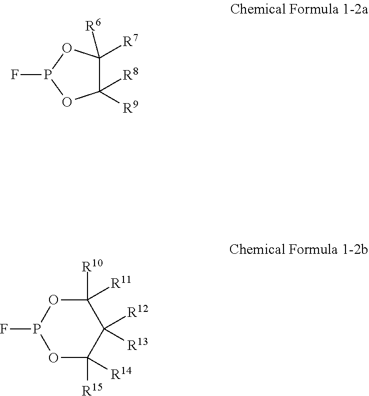

In Chemical Formula 1-2a and Chemical Formula 1-2b, R⁶ to R¹⁵ may each independently be a hydrogen atom, a halogen atom, or a substituted or unsubstituted C1 to C5 alkyl group.

For a more detailed example, the first additive may include at least one compound selected from among:

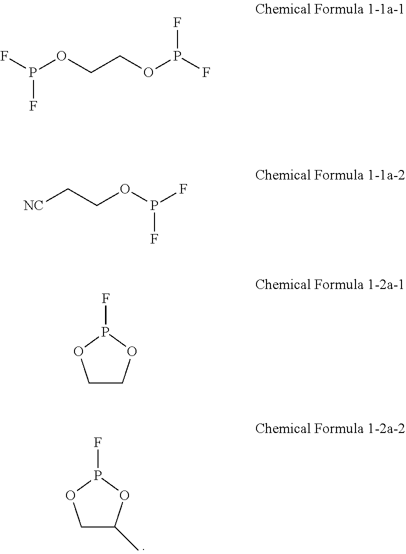

### Second Additive

In Chemical Formula 2, X¹¹ and X¹² may each independently be O or S.

For example, X¹¹ and X¹² are both (e.g., simultaneously) 0.

For a more detailed example, the second additive may include at least one compound selected from among:

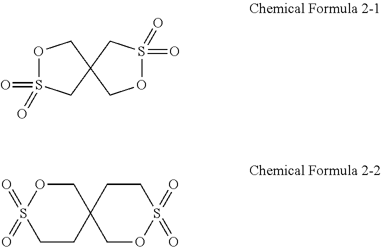 [SMILES: O=S1(=O)CC2(CO1)COS(=O)(=O)C2 ; O=S1(=O)CCC2(CCS(=O)(=O)OC2)CO1]

Mixing Ratio (weight ratio) of First Additive and Second Additive

The weight ratio of the first additive and the second additive may be about 10:1 to about 1:10. Within this range, there is a synergistic effect due to the combination of the above two types (kinds) of additives.

For example, the weight ratio may be about 10:1 to about 1:7, about 10:1 to about 1:5, or about 10:1 to about 1:2.

### Amount of First Additive

The first additive may be included in an amount of about 0.1 to about 5 wt % based on a total amount of 100 wt % of the electrolyte. Within this range, the effect of the first additive can be increased.

For example, the first additive may be included in an amount of about 0.1 wt % to about 3 wt %, about 0.1 wt % to about 2.5 wt %, or about 0.1 wt % to about 1 wt %, based on a total amount of 100 wt % of the electrolyte.

### Amount of Second Additive

The second additive may be included in an amount of about 0.1 wt % to about 5 wt % based on a total amount of 100 wt % of the electrolyte. Within this range, the effect of the second additive can be increased.

For example, the first additive may be included in an amount of about 0.1 wt % to about 3 wt %, about 0.1 wt % to about 2.5 wt %, or about 0.1 wt % to about 5 wt %, based on a total amount of 100 wt % of the electrolyte.

### Non-aqueous Organic Solvent

The non-aqueous organic solvent serves as a medium for transmitting ions taking part in the electrochemical reaction of a battery.

The non-aqueous organic solvent may be a carbonate-based, ester-based, ether-based, ketone-based, alcohol-based solvent, aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and/or the like. The ester-based solvent may include methyl acetate, ethyl acetate, n-propyl acetate, dimethylacetate, methylpropionate, ethylpropionate, decanolide, mevalonolactone, valerolactone(valerolactone), caprolactone, and/or the like. The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone. The alcohol-based solvent may include ethyl alcohol, isopropyl alcohol, and/or the like, and the aprotic solvent may include nitriles such as R—CN (wherein R is a C2 to C20 linear, branched, or cyclic hydrocarbon group, a double bond, an aromatic ring, or an ether group), amides such as dimethylformamide, dioxolanes such as 1,3-dioxolane or 1,4-dioxolane, sulfolanes, and/or the like.

The non-aqueous organic solvent may be used alone or in combination of two or more.

Additionally, if (e.g., when) using a carbonate-based solvent, cyclic carbonate and chain carbonate can be mixed and used, and cyclic carbonate and chain carbonate may be mixed at a volume ratio of about 1:1 to about 1:9.

For example, the non-aqueous organic solvent may be a mixture of ethylene carbonate (EC), ethylmethyl carbonate (EMC), and dimethyl carbonate (DMC). A volume ratio thereof is not particularly limited.

### Lithium Salt

The lithium salt dissolved in the organic solvent supplies lithium ions in a battery, enables a basic operation of a rechargeable lithium battery, and improves transportation of the lithium ions between positive and negative electrodes. Examples of a lithium salt may include one or more than one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (x and y are integers from 1 to 20), lithium trifluoromethane sulfonate, lithium tetrafluoroethanesulfonate, lithium difluorobis(oxalato)phosphate, (LiDFOB), and lithium bis(oxalato)borate (LiBOB).

For example, LiPF₆ can be used as the lithium salt.

A molar concentration of lithium salt in the electrolyte may be about 1.0 M to about 2.0 M.

### (Rechargeable Lithium Battery)

One or more embodiments include a rechargeable lithium battery including a positive electrode including a positive electrode active material; a negative electrode including a negative electrode active material; and the aforementioned electrolyte according to one or more embodiments.

In the rechargeable lithium battery including the electrolyte of the aforementioned embodiment, side reactions (e.g., gas generation, increase in interface resistance, and/or the like) occurring at the interface between the negative electrode and the electrolyte may be suppressed or reduced, and cycle-life may be improved.

Hereinafter, descriptions that overlap with the above will not be provided, and the rechargeable lithium battery will be described in more detail.

### Upper Charging Limit Voltage

As described above, if (e.g., when) a rechargeable lithium battery is charged at high voltage, the amount of elution of transition metal ions in the positive electrode active material increases.

However, if a robust film is formed on the surface of the positive electrode using the aforementioned electrolyte according to one or more embodiments, the elution of transition metal ions in the positive electrode active material may be suppressed or reduced even if (e.g., when) charged at high voltage.

For example, the upper charging limit voltage of the rechargeable lithium battery may be greater than or equal to about 4.3 V, greater than or equal to about 4.4 V, or greater than or equal to about 4.45 V.

### Positive Electrode Active Material

The positive electrode active material may be a compound (lithiated intercalation compound) capable of intercalating and deintercalating lithium. For example, one or more types (kinds) of composite oxides of lithium and a metal selected from among cobalt, manganese, nickel, and/or one or more (e.g., any suitable) combinations thereof may be used.

The composite oxide may be a lithium transition metal composite oxide, and specific examples may include lithium nickel-based oxide, lithium cobalt-based oxide, lithium manganese-based oxide, a lithium iron phosphate-based compound, cobalt-free lithium nickel-manganese-based oxide, and/or a (e.g., any suitable) combination thereof.

As an example, a compound represented by any one selected from among the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O₂₋ₐDₐ (0.90≤a≤1.8, 0≤b≤0.5, 0≤c≤0.5, 0<a<2); LiₐNi_{1-b-c}Mn_{b}X_{c}O₂₋ₐDₐ (0.90≤a≤1.8, 0≤b≤0.5, 0≤c≤0.5, 0<a<2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A is Ni, Co, Mn, and/or a (e.g., any suitable) combination thereof; X is Al, Ni, Co, Mn, Cr, Fe, Mg, Sr, V, a rare earth element, and/or a (e.g., any suitable) combination thereof; D is O, F, S, P, and/or a (e.g., any suitable) combination thereof; G is Al, Cr, Mn, Fe, Mg, La, Ce, Sr, V, and/or a (e.g., any suitable) combination thereof; and L¹ is Mn, Al, and/or a (e.g., any suitable) combination thereof.

The positive electrode active material may be, for example, a lithium nickel-based oxide represented by Chemical Formula 11, a lithium cobalt-based oxide represented by Chemical Formula 12, a lithium iron phosphate-based compound represented by Chemical Formula 13, a cobalt-free lithium nickel-manganese-based oxide represented by Chemical Formula 14, and/or a (e.g., any suitable) combination thereof.

Liₐ₁Niₓ₁M¹_{y1}M²_{z1}O_{2-b1}X_{b1} Chemical Formula 11

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² may each independently be one or more selected from among Al, B, Ba, Ca, Ce, Co, Cr, Cu, Fe, Mg, Mn, Mo, Nb, Si, Sn, Sr, Ti, V, W, and Zr, and X is one or more selected from among F, P, and S.

In Chemical Formula 11, 0.6≤x1≤1, 0≤y1≤0.4, and 0≤z1≤0.4, or 0.8≤x1≤1, 0≤y1≤0.2, and 0≤z1≤0.2.

Liₐ₂Coₓ₂M³_{y2}O_{2-b2}X_{b2} Chemical Formula 12

In Chemical Formula 12, 0.9≤a2≤1.8, 0.7≤x2≤1, 0≤y2≤0.3, 0.9≤x2+y2≤1.1, and 0≤b2≤0.1, M³ is one or more selected from among Al, B, Ba, Ca, Ce, Cr, Cu, Fe, Mg, Mn, Mo, Ni, Se, Si, Sn, Sr, Ti, V, W, Y, Zn, and Zr, and X is one or more selected from among F, P, and S.

Liₐ₃Feₓ₃M⁴_{y3}PO_{4-b3}X_{b3}d Chemical Formula 13

In Chemical Formula 13, 0.9≤a3≤1.8, 0.6≤x3≤1, 0≤y3≤0.4, and 0≤b3≤0.1, M⁴ is one or more selected from among Al, B, Ba, Ca, Ce, Co, Cr, Cu, Mg, Mn, Mo, Ni, Se, Si, Sn, Sr, Ti, V, W, Y, Zn, and Zr, and X is one or more selected from among F, P, and S.

Liₐ₄Niₓ₄Mn_{y4}M⁵_{z4}O_{2-b4}X_{b4} Chemical Formula 14

In Chemical Formula 14, 0.9≤a4≤1.8, 0.8≤x4<1, 0≤y4≤0.2, 0≤z4≤0.2, 0.9≤x4+y4+z4≤1.1, and 0≤b4≤0.1, M⁵ is one or more element selected from among Al, B, Ba, Ca, Ce, Cr, Fe, Mg, Mo, Nb, Si, Sn, Sr, Ti, V, W, and Zr, and X is one or more selected from among F, P, and S.

For example, the positive electrode active material may be a cobalt-free nickel-manganese-based oxide represented by Chemical Formula 14. Because the cobalt-free nickel-manganese-based oxide does not contain cobalt, it has the advantage of being cheaper than the positive electrode active material containing cobalt.

However, the cobalt-free nickel-manganese-based oxide has an unstable structure due to the absence of cobalt, and nickel ions and/or manganese ions are likely to be eluted.

However, if a robust film is formed on the surface of the positive electrode including the cobalt-free nickel-manganese-based oxide using the electrolyte of the aforementioned embodiment, nickel ions and/or elution of manganese ions in the cobalt-free nickel-manganese-based oxide into the electrolyte may be suppressed or reduced. That is, the cobalt-free nickel-manganese-based oxide may exhibit an unstable structure due to the absence of cobalt, resulting in the potential elution of nickel ions and/or manganese ions. However, if a robust film is formed on the positive electrode surface, which includes the cobalt-free nickel-manganese-based oxide and utilizes the electrolyte from the aforementioned embodiment, the release of nickel ions and/or manganese ions into the electrolyte may be mitigated or minimized.

For example, the positive electrode active material may be a high nickel-based positive electrode active material having a nickel content (e.g., amount) of greater than or equal to about 80 mol %, greater than or equal to about 85 mol %, greater than or equal to about 90 mol %, greater than or equal to about 91 mol %, or greater than or equal to about 94 mol %, and less than or equal to about 99 mol % based on 100 mol % of metals excluding lithium in the lithium transition metal composite oxide. The high nickel-based positive electrode active materials can achieve high capacity and can be applied to a high-capacity, high-density rechargeable lithium battery.

However, the high nickel-based positive electrode active material has high nickel activity, so that a large amount of nickel ions are likely to be eluted from the high nickel-based positive electrode active material.

However, if a robust film is formed on the surface of the positive electrode including the high nickel-based positive electrode active material using the electrolyte of the aforementioned embodiment, it is possible to suppress or reduce nickel ions in the high nickel-based positive electrode active material from eluting into the electrolyte.

Also, for example, the positive electrode active material may be a cobalt-free nickel-manganese-based oxide, and may be a high nickel-based positive electrode active material having a nickel content (e.g., amount) of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of metals excluding lithium. Even in this case, the above-described effects can be effectively exhibited.

### Positive Electrode

The positive electrode for a rechargeable lithium battery may include a current collector and a positive electrode active material layer on the current collector. The positive electrode active material layer may include a positive electrode active material and may further include a binder and/or a conductive material.

For example, the positive electrode may further include an additive that can function as a sacrificial positive electrode.

An amount of the positive electrode active material may be about 90 wt % to about 99.5 wt %, and each amount of the binder and the conductive material may be about 0.5 wt % to about 5 wt % based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like, but are not limited thereto.

The conductive material (e.g., the electron conductor) may be used to impart conductivity (e.g., electrical conductivity) to the electrode. Any material that does not cause chemical change (e.g., does not cause an undesirable chemical change in the rechargeable lithium battery) and conducts electrons may be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material including copper, nickel, aluminum, silver, and/or the like, in a form of a metal powder or a metal fiber; a conductive polymer such as a polyphenylene derivative; and/or a (e.g., any suitable) mixture thereof.

The current collector may include Al, but the present disclosure is not limited thereto.

### Negative Electrode Active Material

The negative electrode active material may be a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include a carbon-based negative electrode active material, for example, crystalline carbon, amorphous carbon and/or a (e.g., any suitable) combination thereof. The crystalline carbon may be graphite such as non-shaped, plate-shaped, flake-shaped, sphere-shaped, or fiber-shaped natural graphite or artificial graphite. The amorphous carbon may be a soft carbon, a hard carbon, a mesophase pitch carbonization product, calcined coke, and/or the like.

The lithium metal alloy may include lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x≤2), a Si-Q alloy (wherein Q is selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof). The Sn-based negative electrode active material may include Sn, SnOₓ, e.g., SnO₂, a Sn-based alloy, and/or a (e.g., any suitable) combination thereof.

The silicon-carbon composite may be a composite of silicon and amorphous carbon. According to one or more embodiments, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist as dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

### Negative Electrode

A negative electrode for a rechargeable lithium battery includes a current collector and a negative electrode active material layer on the current collector. The negative electrode active material layer includes a negative electrode active material and may further include a binder and/or a conductive material (e.g., an electron conductor).

For example, the negative electrode active material layer may include about 90 wt % to about 99 wt % of the negative electrode active material, about 0.5 wt % to about 5 wt % of the binder, and about 0.5 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, and/or a (e.g., any suitable) combination thereof.

The aqueous binder may be selected from among a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and/or a (e.g., any suitable) combination thereof.

When an aqueous binder is used as the negative electrode binder, it may further include a cellulose-based compound capable of imparting viscosity. The cellulose-based compound includes one or more of carboxymethyl cellulose, hydroxypropylmethyl cellulose, methyl cellulose, or alkali metal salts thereof. The alkali metal may be Na, K, or Li.

The dry binder may be a polymer material capable of being fiberized, and may be, for example, polytetrafluoroethylene, polyvinylidene fluoride, polyvinylidene fluoride-hexafluoropropylene copolymer, polyethylene oxide, and/or a (e.g., any suitable) combination thereof.

The conductive material is included to provide electrode conductivity, and any electrically conductive material may be used as a conductive material unless it causes a chemical change. Examples of the conductive material may be a carbon-based material such as natural graphite, artificial graphite, carbon black, acetylene black, ketjen black, a carbon fiber, a carbon nanofiber, a carbon nanotube, and/or the like; a metal-based material such as copper, nickel, aluminum silver, and/or the like in a form of a metal powder or a metal fiber; a conductive polymer such as a polyphenylene derivative; and/or a (e.g., any suitable) mixture thereof.

The negative electrode current collector may include one selected from among a copper foil, a nickel foil, a stainless steel foil, a titanium foil, a nickel foam, a copper foam, a polymer substrate coated with a conductive metal, and/or a (e.g., any suitable) combination thereof, but the present disclosure is not limited thereto.

### Separator

Depending on the type or kind of the rechargeable lithium battery, a separator may be present between the positive electrode and the negative electrode. The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and/or the like.

The separator may include a porous substrate and a coating layer including an organic material, an inorganic material, and/or a (e.g., any suitable) combination thereof on one or both surfaces (e.g., opposite surfaces) of the porous substrate.

The porous substrate may be a polymer film formed of any one selected from among a polymer, or a copolymer or mixture of two or more of polyolefin such as polyethylene or polypropylene, a polyester such as polyethyleneterephthalate, or polybutyleneterephthalate, polyacetal, polyamide, polyimide, polycarbonate, polyether ketone, polyaryl ether ketone, polyether imide, polyamideimide, polybenzimidazole, polyether sulfone, polyphenyleneoxide, a cyclic olefin copolymer, polyphenylenesulfide, polyethylenenaphthalate, a glass fiber, TEFLON (tetrafluoroethylene), and polytetrafluoroethylene.

The organic material may include a polyvinylidene fluoride-based polymer or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but the present disclosure is not limited thereto.

The organic material and the inorganic material may be mixed in one coating layer, or a coating layer including an organic material and a coating layer including an inorganic material may be stacked.

### Rechargeable Lithium Battery

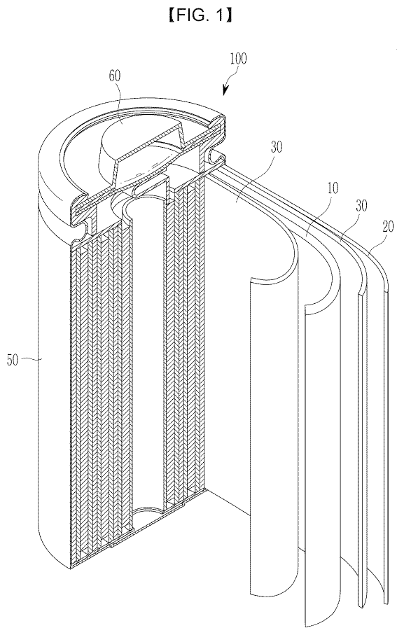

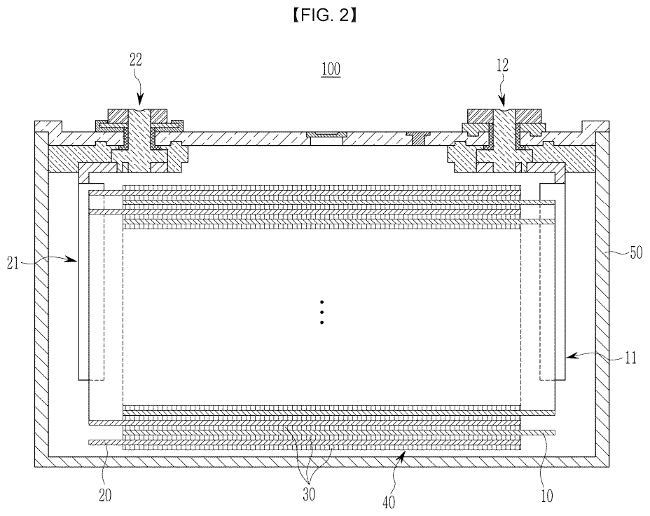

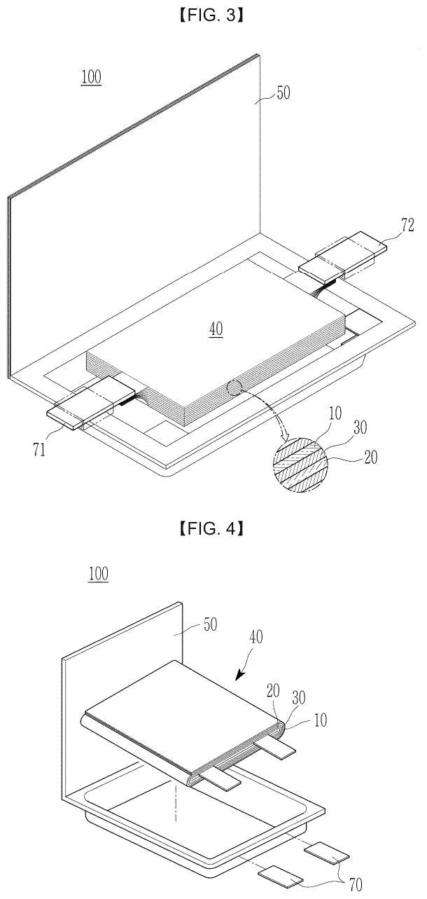

The rechargeable lithium battery may be classified into cylindrical, prismatic, pouch, or coin-type or kind batteries, and/or the like depending on their shape. FIGS. 1 to 4 are schematic views each illustrating a rechargeable lithium battery according to one or more embodiments. FIG. 1 shows a circular battery, FIG. 2 shows a prismatic battery, and FIGS. 3 and 4 each show pouch-type or kind batteries. Referring to FIGS. 1 to 4, the rechargeable lithium battery 100 may include an electrode assembly 40 including a separator 30 between a positive electrode 10 and a negative electrode 20, and a case 50 in which the electrode assembly 40 is housed. The positive electrode 10, the negative electrode 20, and the separator 30 may be impregnated with an electrolyte. The rechargeable lithium battery 100 may include a sealing member 60 sealing the case 50 as shown in FIG. 1. In addition, in FIG. 2, the rechargeable lithium battery 100 may include a positive lead tab 11, a positive terminal 12, a negative lead tab 21, and a negative terminal 22. As shown in FIGS. 3 and 4, the rechargeable lithium battery 100 includes an electrode tab 70, that is, a positive electrode tab 71 and a negative electrode tab 72 serving as an electrical path for inducing the current formed in the electrode assembly 40 to the outside.

The rechargeable lithium battery according to one or more embodiments may be applied to automobiles, mobile phones, and/or one or more suitable types (kinds) of electrical devices, but the present disclosure is not limited thereto.

Hereinafter, examples of the present disclosure and comparative examples are described in more detail. These examples, however, are not in any sense to be interpreted as limiting the scope of present disclosure.

### Example 1

### (1) Preparation of Electrolyte

As a non-aqueous organic solvent, a carbonate-based solvent prepared by mixing ethylene carbonate (EC):ethylmethyl carbonate (EMC):dimethyl carbonate (DMC) in a volume ratio of 20:40:40 was used.

The non-aqueous organic solvent was mixed with 1.5 M lithium salt (LiPF₆), and 0.5 wt % of a first additive represented by Chemical Formula 1-2a-2 and 0.25 wt % of a second additive represented by Chemical Formula 2-1 were added thereto to obtain an electrolyte.

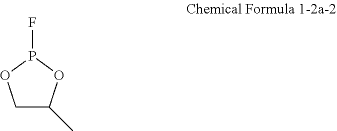

### 2-fluoro-4-methyl-1,3,2-dioxaphospholane (CAS No.: 16415-09-1)

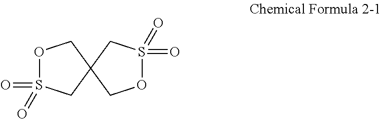 [SMILES: O=S1(=O)CC2(CO1)COS(=O)(=O)C2]

### 2,7-dioxa-3,8-dithiaspiro[4.4]nonane 3,3,8,8-tetraoxide (CAS No.: 1679-27-2)

(However, in the electrolyte composition, “wt %” was based on a total amount of 100 wt % of the electrolyte (lithium salt+non-aqueous organic solvent+additive. Hereinafter, the same as above was applied.)

### (2) Manufacturing of Rechargeable Lithium Battery Cell

LiNi_{0.75}Mn_{0.23}Al_{0.02}O₂ as a positive electrode active material, polyvinylidene fluoride as a binder, and acetylene black as a conductive material were mixed in a weight ratio of 96:3:1 and then, dispersed in N-methyl pyrrolidone to prepare positive electrode active material slurry.

The positive electrode active material slurry was coated on a 14 μm-thick Al foil and then, dried at 110° C. and pressed to manufacture a positive electrode. That is, the positive electrode was produced by applying a slurry of active material onto a 14 μm-thick Al foil, followed by drying at 110° C. and compression to form the electrode.

Conversely, a negative electrode active material slurry was prepared by using a mixture of artificial graphite and silicon particles in a weight ratio of 93.5:6.5 as a negative electrode active material and mixing the negative electrode active material: styrene-butadiene rubber binder:carboxymethyl cellulose in a weight ratio of 97:1:2 and then, dispersing this obtained mixture in distilled water.

The negative electrode active material slurry was coated on a 10 μm-thick Cu foil, dried at 100° C., and pressed to manufacture a negative electrode.

The positive and negative electrodes were assembled with a 25 μm-thick polyethylene separation membrane to manufacture an electrode assembly, the electrode assembly was housed in a prismatic case, and the electrolyte was implanted thereinto, manufacture a rechargeable lithium battery cell.

### Example 2

An electrolyte and a rechargeable lithium battery cell according to Example 2 were manufactured in substantially the same manner as in Example 1 except that the amounts of the first additive represented by Chemical Formula 1-2a-2 and the second additive represented by Chemical Formula 2-2 were respectively changed to 0.5 wt % and 0.1 wt %.

### Example 3

An electrolyte and a rechargeable lithium battery cell according to Example 3 were manufactured in substantially the same manner as in Example 1 except that the amounts of the first additive represented by Chemical Formula 1-2a-2 and the second additive represented by Chemical Formula 2-2 were respectively changed to 0.5 wt % and 0.3 wt %.

### Example 4

An electrolyte and a rechargeable lithium battery cell according to Example 4 were manufactured in substantially the same manner as in Example 1 except that the amounts of the first additive represented by Chemical Formula 1-2a-2 and the second additive represented by Chemical Formula 2-2 were respectively changed to 0.5 wt % and 1.0 wt %.

### Example 5

An electrolyte and a rechargeable lithium battery cell according to Example 5 were manufactured in substantially the same manner as in Example 1 except that the amounts of the first additive represented by Chemical Formula 1-2a-2 and the second additive represented by Chemical Formula 2-1 were respectively changed to 1.0 wt % and 0.5 wt %.

### Example 6

An electrolyte and a rechargeable lithium battery cell according to Example 5 were manufactured in substantially the same manner as in Example 1 except that LiNi_{0.91}Co_{0.04}Al_{0.05}O₂ instead of the LiNi_{0.75}Mn_{0.23}Al_{0.02}O₂ was used as the positive electrode active material.

### Comparative Example 1 (Ref.)

### (1) Preparation of Electrolyte

An electrolyte was prepared by mixing ethylene carbonate (EC):ethylmethyl carbonate (EMC):dimethyl carbonate (DMC) in a volume ratio of 20:40:40 to prepare a carbonate-based solvent and dissolving 1.5 M lithium salt (LiPF₆) therein.

### (2) Manufacture of Rechargeable Lithium Battery Cell

A rechargeable lithium battery cell was manufactured in substantially the same manner as in Example 1 except that the electrolyte was used.

### Comparative Example 2

### (1) Preparation of Electrolyte

As a non-aqueous organic solvent, a carbonate-based solvent prepared by mixing ethylene carbonate (EC):ethylmethyl carbonate (EMC):dimethyl carbonate (DMC) in a volume ratio of 20:40:40 was used.

The non-aqueous organic solvent was mixed with 1.5 M lithium salt (LiPF₆), and 0.5 wt % of the third additive represented by Chemical Formula 3 was added thereto to obtain an electrolyte of Comparative Example 2

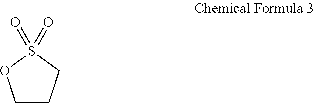

### 1,2-oxathiolane 2,2-dioxide (CAS No.: 1120-71-4)

### (2) Manufacture of Rechargeable Lithium Battery Cell

A rechargeable lithium battery cell was manufactured in substantially the same manner as in Example 1 except that the electrolyte was used.

### Comparative Example 3

### (1) Preparation of Electrolyte

As a non-aqueous organic solvent, a carbonate-based solvent prepared by mixing ethylene carbonate (EC):ethylmethyl carbonate (EMC):dimethyl carbonate (DMC) in a volume ratio of 20:40:40 was used.

The non-aqueous organic solvent was mixed with 1.5 M lithium salt (LiPF₆), and 0.5 wt % of the first additive represented by Chemical Formula 1-2a-2 was added thereto to obtain an electrolyte of Comparative Example 3.

### (2) Manufacture of Rechargeable Lithium Battery Cell

A rechargeable lithium battery cell of Comparative Example 3 was manufactured in substantially the same manner as in Example 1 except that the electrolyte was used.

### Comparative Example 4

### (1) Preparation of Electrolyte

As a non-aqueous organic solvent, a carbonate-based solvent prepared by mixing ethylene carbonate (EC):ethylmethyl carbonate (EMC):dimethyl carbonate (DMC) in a volume ratio of 20:40:40 was used.

The non-aqueous organic solvent was mixed with 1.5 M lithium salt (LiPF₆), and 0.5 wt % of the second additive represented by Chemical Formula 2-2 was added thereto to obtain an electrolyte of Comparative Example 4.

### (2) Manufacture of Rechargeable Lithium Battery Cell

A rechargeable lithium battery cell of Comparative Example 4 was manufactured in substantially the same manner as in Example 1 except that the electrolyte was used.

### Comparative Example 5

### (1) Preparation of Electrolyte

As a non-aqueous organic solvent, a carbonate-based solvent prepared by mixing ethylene carbonate (EC):ethylmethyl carbonate (EMC):dimethyl carbonate (DMC) in a volume ratio of 20:40:40 was used.

The non-aqueous organic solvent was mixed with 1.5 M lithium salt (LiPF₆), and 0.5 wt % of a first additive represented by Chemical Formula 1-2a-2, 0.5 wt % of a first additive represented by Chemical Formula 1-2a-2, and 0.5 wt % of the third additive represented by Chemical Formula 3 were added thereto to obtain an electrolyte of Comparative Example 5.

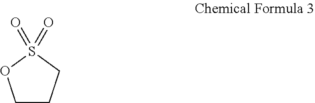

### 1,2-oxathiolane 2,2-dioxide (CAS No.: 1120-71-4)

### (2) Manufacture of Rechargeable Lithium Battery Cell

A rechargeable lithium battery cell of Comparative Example 5 was manufactured in substantially the same manner as in Example 1 except that the electrolyte was used.

For reference, the positive electrode active material composition and additive amount in the electrolytes of Examples 1 to 6 and Comparative Examples 1 to 5 are summarized in Table 1.

TABLE 1

| | | Additive amount in the electrolytes (wt %) | | |
|---|---|---|---|---|
| | Positive electrode active | First | Second | Third |
| | material composition | additive | additive | additive |
| Example 1 | LiNi_{0.75}Mn_{0.23}Al_{0.02}O₂ | 0.5 | 0.5 | — |
| Example 2 | LiNi_{0.75}Mn_{0.23}Al_{0.02}O₂ | 0.5 | 0.1 | — |
| Example 3 | LiNi_{0.75}Mn_{0.23}Al_{0.02}O₂ | 0.5 | 0.3 | — |
| Example 4 | LiNi_{0.75}Mn_{0.23}Al_{0.02}O₂ | 0.5 | 1.0 | — |
| Example 5 | LiNi_{0.75}Mn_{0.23}Al_{0.02}O₂ | 1.0 | 0.5 | — |
| Example 6 | LiNi_{0.91}Co_{0.04}Al_{0.05}O₂ | 0.5 | 0.5 | — |
| Comparative | LiNi_{0.75}Mn_{0.23}Al_{0.02}O₂ | — | — | — |
| Example 1 | | | | |
| Comparative | LiNi_{0.75}Mn_{0.23}Al_{0.02}O₂ | — | — | 0.5 |
| Example 2 | | | | |
| Comparative | LiNi_{0.75}Mn_{0.23}Al_{0.02}O₂ | 0.5 | — | — |
| Example 3 | | | | |
| Comparative | LiNi_{0.75}Mn_{0.23}Al_{0.02}O₂ | — | 0.5 | — |
| Example 4 | | | | |
| Comparative | LiNi_{0.75}Mn_{0.23}Al_{0.02}O₂ | 0.5 | — | 0.5 |
| Example 5 | | | | |

### Evaluation Example 1: Cycle-life Characteristics Depending on Temperature

Each of the rechargeable lithium battery cells of Examples 1 to 7 and Comparative Examples 1 to 6 was evaluated with respect to cycle-life characteristics according to a temperature in the following methods, and the results are shown in Table 2.

### (1) Room-Temperature Cycle-Life Characteristics

The rechargeable lithium battery cells were 400 cycles charged and discharged under conditions of 0.33 C charge (CC/CV, 4.45 V, 0.025 C Cut-off)/1.0 C discharge (CC, 2.5 V Cut-off) at 25° C., and a capacity retention rate thereof was calculated according to Equation 1.

### (2) High-Temperature Cycle-Life Characteristics

The cells were 400 cycles charged and discharged under conditions of 0.33 C charge (CC/CV, 4.45 V, 0.025 C Cut-off)/1.0 C discharge (CC, 2.5 V Cut-off) at 45° C., and a capacity retention rate thereof was calculated according to Equation 1.

$$Equation 1$$

$$Capacity retention rate [ \% ] = ( Discharge capacity after 200 cycles / Discharge capacity after 1 cycle ) * 100$$

### Evaluation Example 2: High-temperature Storage Characteristics

The rechargeable lithium battery cells of Examples 1 to 6 and Comparative Examples 1 to 5 were stored at a high temperature (60° C.) in the following methods to evaluate DC-IR increase rates, and the results are shown in Table 2.

The rechargeable lithium battery cells immediately after the manufacture were measured with respect to ΔV/ΔI (voltage change/current change) to evaluate initial DC resistance (initial DC-IR).

The rechargeable lithium battery cells after the high temperature storage under the conditions of (1) above was measured with respect to ΔV/ΔI (voltage change/current change) to evaluate DC internal resistance (DC-IR after the high temperature storage).

A DC-IR increase rate was calculated according to Equation 3, and the results are shown in Table 2.

$$Equation 3$$

$$DC - IR increase [ \% ] = ( DC - IR after high - temperature storage / initial DC - IR ) * 100$$

TABLE 2

| | | | Storage |
|---|---|---|---|
| | | | characteristics at a |
| | | | high temperature |
| | Cycle-life characteristics | | DC-IR increase |
| | Capacity retention | Capacity retention | rate |
| | rate | rate | @ 60° C., |
| | @ 25° C., | @ 45° C., | 60 Day |
| | 400 Cyc. [%] | 400 Cyc. [%] | [%] |
| Example 1 | 93.3 | 90.2 | 115.8 |
| Example 2 | 91.9 | 88.9 | 127.2 |
| Example 3 | 91.6 | 89.1 | 120.6 |
| Example 4 | 92.9 | 89.5 | 125.0 |
| Example 5 | 92.8 | 89.3 | 124.8 |
| Example 6 | 92.1 | 88.8 | 126.5 |
| Comparative | 85.4 | 81.4 | 146.2 |
| Example 1 | | | |
| Comparative | 89.5 | 85.1 | 130.8 |
| Example 2 | | | |
| Comparative | 91.2 | 88.2 | 127.3 |
| Example 3 | | | |
| Comparative | 90.3 | 87.5 | 129.1 |
| Example 4 | | | |
| Comparative | 89.9 | 86.4 | 121.5 |
| Example 5 | | | |

According to Table 2, cycle-life characteristics at room temperature and high temperature are improved, and DC-IR increase is suppressed or reduced after high temperature storage.

Each of the electrolytes according to one or more embodiments represented by Examples 1 to 6 suppresses or reduces the elution of transition metal ions in the positive electrode active material, regardless of the operating temperature and upper charge limit voltage, and prevents side reactions (e.g., prevents gas generation, increase in interface resistance, and/or the like) and improves the cycle-life of lithium secondary battery cells.

Among them, according to Examples 1 to 5, if (e.g., when) a robust film is formed on the surface of the positive electrode including the cobalt-free nickel-manganese-based oxide, using the electrolytes according to one or more embodiments, elution of nickel ions and/or manganese ions in the cobalt-free nickel-manganese-based oxide into the electrolyte can be suppressed or reduced.

In addition, it is also possible to control the effect by adjusting the mixing ratio (weight ratio) of the first additive and the second additive with reference to Examples 1 to 5.

A battery manufacturing device, a battery management system (BMS) device, and/or any other relevant devices or components according to embodiments of the present disclosure described herein may be implemented utilizing any suitable hardware, firmware (e.g. an application-specific integrated circuit), software, or a combination of software, firmware, and hardware. For example, the one or more suitable components of the device may be formed on one integrated circuit (IC) chip or on separate IC chips. Further, the one or more suitable components of the device may be implemented on a flexible printed circuit film, a tape carrier package (TCP), a printed circuit board (PCB), or formed on one substrate. Further, the one or more suitable components of the device may be a process or thread, running on one or more processors, in one or more computing devices, executing computer program instructions and interacting with other system components for performing the one or more suitable functionalities described herein. The computer program instructions are stored in a memory which may be implemented in a computing device utilizing a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of one or more suitable computing devices may be combined or integrated into a single computing device, or the functionality of a particular computing device may be distributed across one or more other computing devices without departing from the scope of the present disclosure.

While this disclosure has been described in connection with what is presently considered to be practical example embodiments, it is to be understood that present disclosure is not limited to the disclosed embodiments, but, on the contrary, is intended to cover one or more suitable modifications and equivalent arrangements included within the spirit and scope of the appended claims and equivalents thereof.

### REFERENCE NUMERALS

| | |
|---|---|
| 100: rechargeable lithium battery | 10: positive electrode |
| 11: positive electrode lead tab | 12: positive terminal |
| 20: negative electrode | 21: negative electrode lead tab |
| 22: negative terminal | 30: separator |
| 40: electrode assembly | 50: case |
| 60: sealing member | 70: electrode tab |
| 71: positive electrode tab | 72: negative electrode tab |

What is claimed is:

1. An electrolyte comprising
a non-aqueous organic solvent;
a lithium salt;
a first additive represented by Chemical Formula 1; and
a second additive represented by Chemical Formula 2: 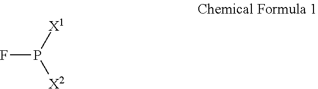
wherein, in Chemical Formula 1:
X¹ and X² are each a halogen or —O-L¹-R¹, provided that at least one selected from among X¹ and/or X² is —O-L¹-R¹;
L¹ is a single bond, or a substituted or unsubstituted C1 to C10 alkylene group;
R¹ is a cyano group (—CN), a difluorophosphite group (—OPF₂), a substituted or unsubstituted C1 to C10 alkyl group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group; and
when X¹ and X² are each —O-L¹-R¹ at the same time, then
R¹s are
each independently present, or
two R¹s are linked to form
a substituted or unsubstituted monocyclic or a polycyclic C6 to C20 aliphatic heterocycle, or
a substituted or unsubstituted monocyclic or a polycyclic C6 to C20 aromatic heterocycle, 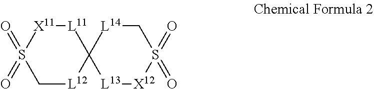
wherein, in Chemical Formula 2,
X¹¹ and X¹² are each independently O or S, and
L¹¹ to L¹⁴ are each independently a single bond, a carbonyl group, a sulfinyl group, or a substituted or unsubstituted C1 to C10 alkylene group, and
wherein the electrolyte is for a rechargeable lithium battery.

2. The electrolyte as claimed in claim 1, wherein, in Chemical Formula 1:
one selected from among X¹ and X² is a fluoro atom and the other is —O-L²-R²;
one selected from among X¹ and X² is —O-L³-R³ and the other is —O-L⁴-R⁴;
L² is a single bond or a substituted or unsubstituted C1 to C10 alkylene group;
R² is a cyano group (—CN) or a difluorophosphite group (—OPF₂); and
L³ and L⁴ are each independently a single bond, or a substituted or unsubstituted C1 to C10 alkylene group, and
wherein:
R³ and R⁴ are each independently a substituted or unsubstituted C1 to C10 alkyl group; or
R³ and R⁴ are linked to form a substituted or unsubstituted monocyclic or polycyclic C3 to C10 aliphatic heterocycle.

3. The electrolyte as claimed in claim 2, wherein
Chemical Formula 1 is represented by Chemical Formula 1-1 or Chemical Formula 1-2: 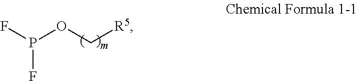
wherein, in Chemical Formula 1-1,
m is an integer of 1 to 5; and
R⁵ is a cyano group (—CN) or a difluorophosphite group (—OPF₂); 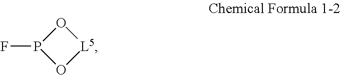
wherein, in Chemical Formula 1-2,
L⁵ is a substituted or unsubstituted C1 to C5 alkylene group.

4. The electrolyte as claimed in claim 3, wherein
Chemical Formula 1-2 is represented by Chemical Formula 1-2a or Chemical Formula 1-2b: 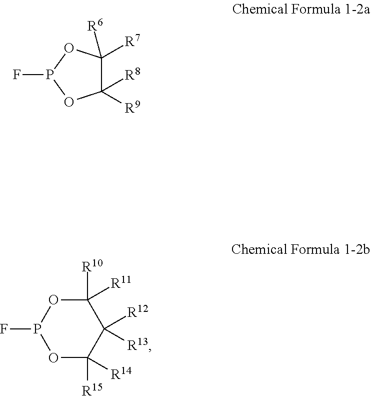
and
wherein, in Chemical Formula 1-2a and Chemical Formula 1-2b,
R⁶ to R¹⁵ are each independently hydrogen atom, a halogen atom, or a substituted or unsubstituted C1 to C5 alkyl group.

5. The electrolyte as claimed in claim 1, wherein
the first additive comprises at least one compound selected from among:

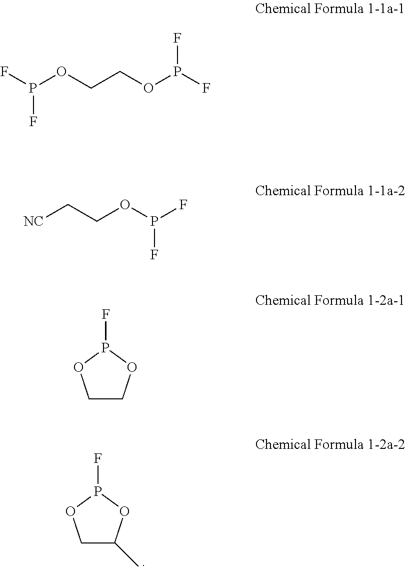

6. The electrolyte as claimed in claim 1, wherein
in Chemical Formula 2,
X¹¹ and X¹² are both O.

7. The electrolyte as claimed in claim 1, wherein
the second additive comprises at least one compound selected from among:

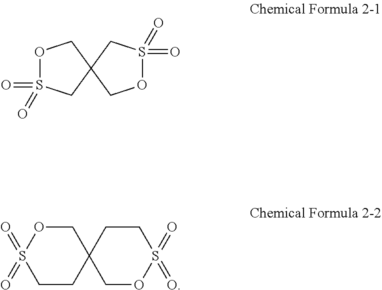 [SMILES: O=S1(=O)CC2(CO1)COS(=O)(=O)C2 ; O=S1(=O)CCC2(CCS(=O)(=O)OC2)CO1]

8. The electrolyte as claimed in claim 1, wherein
a weight ratio of the first additive and the second additive is about 10:1 to about 1:10.

9. The electrolyte as claimed in claim 1, wherein
the first additive is included in an amount of about 0.1 wt % to about 5 wt % based on a total amount of 100 wt % of the electrolyte.

10. The electrolyte as claimed in claim 1, wherein
the second additive is included in an amount of about 0.1 wt % to about 5 wt % based on a total amount of 100 wt % of the electrolyte.

11. The electrolyte as claimed in claim 1, wherein
the non-aqueous organic solvent comprises a mixture of ethylene carbonate (EC), ethylmethyl carbonate (EMC), and dimethyl carbonate (DMC).

12. The electrolyte as claimed in claim 1, wherein
the lithium salt comprises LiPF₆.

13. The electrolyte as claimed in claim 1, wherein
a molar concentration of lithium salt in the electrolyte is about 1.0 M to about 2.0 M.

14. A rechargeable lithium battery comprising
a positive electrode comprising a positive electrode active material;
a negative electrode comprising a negative electrode active material; and
the electrolyte as claimed in claim 1.

15. The rechargeable lithium battery as claimed in claim 14, wherein
the positive electrode active material comprises lithium nickel-based oxide, lithium cobalt-based oxide, lithium manganese-based oxide, a lithium iron phosphate-based compound, cobalt-free lithium nickel-manganese-based oxide, or a combination thereof.

16. The rechargeable lithium battery as claimed in claim 15, wherein
the positive electrode active material comprises a cobalt-free lithium nickel-manganese-based oxide represented by Chemical Formula 14:
Liₐ₄Niₓ₄Mn_{y4}M⁵_{z4}O_{2-b4}X_{b4}, and Chemical Formula 14
wherein, in Chemical Formula 14, 0.9≤a4≤1.8, 0.8≤x4<1, 0≤y4≤0.2, 0≤z4≤0.2, 0.9≤x4+y4+z4≤1.1, and 0≤b4≤0.1, M⁵ is one or more element selected from among Al, B, Ba, Ca, Ce, Cr, Fe, Mg, Mo, Nb, Si, Sn, Sr, Ti, V, W, and Zr, and X is one or more selected from among F, P, and S.

17. The rechargeable lithium battery as claimed in claim 14, wherein
the rechargeable lithium battery further comprises a separator located between the positive electrode and the negative electrode and impregnated with the electrolyte.

18. The rechargeable lithium battery as claimed in claim 14, wherein
an upper charging limit voltage of the rechargeable lithium battery is greater than or equal to about 4.45 V.
